(19) United States
(12) Patent Application Publication
(10) Pub. No.: US 2026/0348472 A1
(43) Pub. Date: Nov. 5, 2026

(54) PRIMARY AND SECONDARY DOUBLE-ROW SHALLOW GROOVE MECHANICAL SEAL END SURFACE STRUCTURE SUITABLE FOR LASER PROCESSING

(71) Applicant: TSINGHUA UNIVERSITY, Beijing (CN)

(72) Inventors: Weifeng HUANG, Beijing (CN); Qiang HE, Beijing (CN); Fengming HU, Beijing (CN); Ying LIU, Beijing (CN); Xiangfeng LIU, Beijing (CN)

(21) Appl. No.: 19/720,952

(22) Filed: Jun. 26, 2026

Related U.S. Application Data
(63) Continuation of application No. PCT/CN2024/127034, filed on Oct. 24, 2024.

(30) Foreign Application Priority Data
Dec. 27, 2023 (CN) 202311826452.0

(51) Int. Cl. F16J 15/34

(52) U.S. Cl. CPC F16J 15/3424

(57) ABSTRACT

Disclosed in the present invention is a primary and secondary double-row shallow groove mechanical seal end surface structure suitable for laser processing, comprising a centro-symmetrically distributed double-row groove structure arranged on a seal ring end surface. The double-row groove structure comprises multiple fan-shaped main grooves and multiple reverse grooves; the multiple fan-shaped main grooves are located on a high-pressure side of the seal ring end surface; each fan-shaped main groove converges from the high-pressure side to a low-pressure side; each fan-shape main groove comprises multiple stepped grooves distributed from the high-pressure side to the low-pressure side and suitable for laser processing; the depth of each fan-shaped main groove increases at equal intervals from the high-pressure side to the low-pressure side; the multiple reverse grooves are located on the low-pressure side of the seal ring end surface; and the depth of each reverser groove remains unchanged.

### CROSS-REFERENCE TO RELATED APPLICATION

This application is a continuation of International Patent Application No. PCT/CN2024/127034 filed on Oct. 24, 2024, which claims a priority to Chinese Patent Application No. 202311826452.0, filed on Dec. 27, 2023, the entire content of which is incorporated herein by reference.

### FIELD

The present disclosure relates to the technical field of fluid sealing, and in particular, to a primary-secondary double-row shallow-groove mechanical seal end-surface structure adapted for laser processing.

### BACKGROUND

At present, common groove sealing structures generate a bearing capacity by virtue of a hydrostatic effect and hydrodynamic pressure, and utilize a pumping effect of a reverse groove. A specific geometric shape is formed between sealing end surfaces. A pressure drop of a pressure fluid across the end surfaces produces a hydrostatic pressure effect, which is only related to pressure and independent of a rotational speed. For sealing of a reverse groove structure, a tangential angle of a weir region of the reverse groove structure causes fluid flow in a groove region, to generate a hydrodynamic effect, thus creating additional pressure and further producing the bearing capacity. A sealing operating based on the hydrostatic effect boasts an advantage that opening of the end surfaces can be realized even at a zero rotational speed, coupled with a relatively large film thickness that can facilitate discharge of some particulate contaminants. However, a sealing device that operates based on the hydrodynamic effect can only achieve the opening of the end surfaces at a predetermined rotational speed. Before the end surfaces are not opened, a problem of wear on the sealing end surfaces occurs, which affects a service life of the sealing device. Currently, mechanical sealing in engineering applications cannot balance advantages of wear and low leakage, easily presenting two scenarios. A first scenario is that the low leakage is achievable but accompanied by severe wear, resulting in a short service life of the sealing. A second scenario is that reduced wear is attained, but with a high leakage rate.

### SUMMARY

The present disclosure aims to solve at least one of the technical problems existing in the prior art. To this end, an objective of the present disclosure is to provide a primary-secondary double-row shallow-groove mechanical seal end-surface structure adapted for laser processing, which can simultaneously achieve advantages of a low leakage rate and small wear at a sealing end surface, have a long service life, and be adapted for laser processing.

The primary-secondary double-row shallow-groove mechanical seal end-surface structure adapted for laser processing according to the embodiments of the present disclosure includes a double-row groove structure arranged in a centrosymmetric distribution at an end surface of a sealing ring. The double-row groove structure includes: a plurality of fan-shaped primary grooves located at a high-pressure side of the end surface of the sealing ring; and a plurality of reverse grooves located at a low-pressure side of the end surface of the sealing ring. Each of the plurality of fan-shaped primary grooves converges from the high-pressure side to the low-pressure side, each of the plurality of fan-shaped primary grooves includes a plurality of stepped grooves distributed in a direction from the high-pressure side to the low-pressure side and adapted for laser processing, and a depth of each of the plurality of fan-shaped primary grooves increases equidistantly in the direction from the high-pressure side to the low-pressure side, and each of the plurality of reverse grooves has the same depth.

The working principle of the primary-secondary double-row shallow-groove mechanical seal end-surface structure adapted for laser processing according to the embodiments of the present disclosure is as follows. When a rotating ring is in a static state or normal operation state, since the plurality of fan-shaped primary grooves are arranged at the high-pressure side of the end surface of the sealing ring, and each of the plurality of fan-shaped primary grooves converges from the high-pressure side to the low-pressure side and includes the plurality of stepped grooves distributed in the direction from the high-pressure side to the low-pressure side, a high-pressure fluid may enter the end surface of the sealing ring through the stepped grooves on the sealing ring, which can effectively generate and enhance a hydrostatic effect, increase a thickness of a fluid film between the rotating ring and a stationary ring, and thus effectively avoid friction and wear at end surfaces of the rotating ring and the stationary ring. The leaked fluid enters the end surface of the sealing ring through the stepped grooves and then flows into the reverse grooves at the end surface of the sealing ring. When the rotating ring rotates, under a throttling effect of a second dam region and a second weir region, the reverse grooves pump the fluid radially and tangentially, which increases fluid pressure at the low-pressure side, and thus can effectively reduce sealing leakage. Meanwhile, a relatively large fluid film thickness is maintained to avoid collision and wear between sealing rings, and good rigidity is achieved. Moreover, as a rotational speed increases, a reverse pumping effect on the low-pressure side is enhanced, and the leakage rate is further reduced.

With the primary-secondary double-row shallow-groove mechanical seal end-surface structure adapted for laser processing according to the embodiments of the present disclosure, by combining a hydrodynamic effect and the hydrostatic effect of the fluid, on the one hand, when the rotating ring is in the static state or normal operation state, a fluid film with a relatively large thickness can be obtained, which can effectively avoid the friction and wear at the end surfaces of the rotating ring and the stationary ring, thus prolonging a service life of a sealing device. On the other hand, through the reverse pumping effect of the reverse grooves at the low-pressure side, leakage of the sealing device is inhibited, and a sealing leakage rate is effectively reduced, thus achieving a favorable sealing effect. Therefore, the primary-secondary double-row shallow-groove mechanical seal end-surface structure adapted for laser processing according to the embodiments of the present disclosure is applicable to low-rotational-speed operating conditions, which can realize the opening of the end surfaces at zero rotational speed, simultaneously achieve the advantages of small wear and the low leakage rate at the end surface of the sealing ring, satisfy performance requirements of the sealing device for a long service life, high rigidity, and low leakage, and be adapted for laser processing with convenient manufacturing.

In some embodiments, a size of a single reverse groove is smaller than a size of a single fan-shaped primary groove.

In some embodiments, a radial proportion of each of the plurality of reverse grooves ranges from 0.1 to 0.15, and a radial proportion of each of the plurality of fan-shaped primary grooves ranges from 0.6 to 0.8.

In some embodiments, a depth of a single stepped groove ranges from 2 μm to 5 μm, and a depth of each of the plurality of reverse grooves ranges from 15 μm to 25 μm.

In some embodiments, a radial groove wall line of each of the plurality of stepped grooves is a straight line, a circular arc line, or a spiral line.

In some embodiments, the spiral line has a helix angle ranging from 80° to 90°.

In some embodiments, a curvature of a circumferential inner groove wall line of each of the plurality of stepped grooves is greater than or equal to a curvature of the sealing ring.

In some embodiments, a radial groove wall line of each of the plurality of reverse grooves is a logarithmic spiral line, an Archimedean spiral line, a straight line, or a circular arc line.

In some embodiments, the number of fan-shaped primary grooves ranges from 12 to 24, the number of stepped grooves in a single fan-shaped primary groove ranges from 8 to 12, and the number of reverse grooves ranges from 48 to 96.

In some embodiments, in a radial direction of the end surface of the sealing ring, a first dam region is formed between a circular ring region where the plurality of fan-shaped primary grooves are located and a circular ring region where the plurality of reverse grooves are located, and a second dam region is formed at an inner side of the circular ring region where the plurality of reverse grooves are located; and in a circumferential direction of the end surface of the sealing ring, a first weir region is formed between every two adjacent fan-shaped primary grooves in the plurality of fan-shaped primary grooves, and a second weir region is formed between every two adjacent reverse grooves in the plurality of reverse grooves.

Additional aspects and advantages of the present disclosure will be provided in part in the following description, or will become apparent in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a schematic structural view of a primary-secondary double-row shallow-groove mechanical seal end-surface structure adapted for laser processing according to an embodiment of the present disclosure;

FIG. 2 is a schematic structural view of a primary-secondary double-row shallow-groove mechanical seal end-surface structure adapted for laser processing according to another embodiment of the present disclosure; and

FIG. 3 is a schematic structural view of a primary-secondary double-row shallow-groove mechanical seal end-surface structure adapted for laser processing according to yet another embodiment of the present disclosure.

### REFERENCE NUMERALS

primary-secondary double-row shallow-groove mechanical seal end-surface structure 1000; double-row groove structure 100; fan-shaped primary groove 101; stepped groove 1011; reverse groove 102; first dam region 103; second dam region 104; first weir region 105; second weir region 106.

### DETAILED DESCRIPTION

Embodiments of the present disclosure will be described in detail below, and examples of the embodiments are shown in the accompanying drawings, in which identical or similar reference signs denote identical or similar elements or elements with identical or similar functions through the accompanying drawings. The following embodiments described with reference to the drawings are illustrative and intended to explain the present disclosure, rather than being interpreted as limitations on the present disclosure.

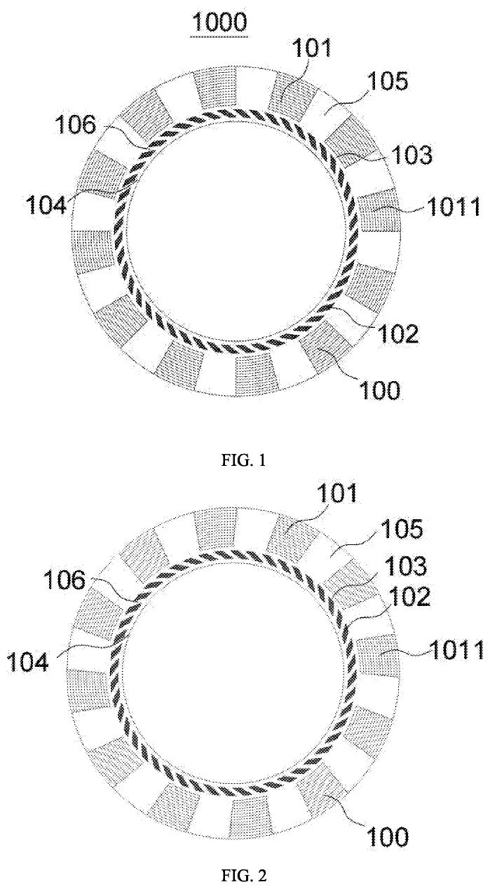

As shown in FIG. 1 to FIG. 3, a primary-secondary double-row shallow-groove mechanical seal end-surface structure 1000 adapted for laser processing according to the embodiments of the present disclosure includes a double-row groove structure 100 arranged in a centrosymmetric distribution at an end surface of a sealing ring. The double-row groove structure 100 includes: a plurality of fan-shaped primary grooves 101 located at a high-pressure side of the end surface of the sealing ring; and a plurality of reverse grooves 102 located at a low-pressure side of the end surface of the sealing ring. Each of the plurality of fan-shaped primary grooves 101 converges from the high-pressure side to the low-pressure side. Each of the plurality of fan-shaped primary grooves 101 includes a plurality of stepped grooves 1011 distributed in a direction from the high-pressure side to the low-pressure side and adapted for laser processing. A depth of each of the plurality of fan-shaped primary grooves 101 increases equidistantly in the direction from the high-pressure side to the low-pressure side. Each of the plurality of reverse grooves 102 has the same depth.

In some embodiments, the end surface of the sealing ring may be understood as an end surface of the rotating ring or the stationary ring. The double-row groove structure 100 may be arranged in a centrosymmetric distribution at the end surface of the stationary ring or the rotating ring. A radially outer side of the sealing ring is the high-pressure side, i.e., an upstream side. A radially inner side of the sealing ring is the low-pressure side, i.e., a downstream side. The double-row groove structure 100 includes the plurality of fan-shaped primary grooves 101 and the plurality of reverse grooves 102. For example, the number of fan-shaped primary grooves 101 may range from 12 to 24, which can ensure a sealing effect of a mechanical sealing device. The number of reverse grooves 102 may range from 48 to 96, which can ensure a fluid pumping capacity of the reverse grooves 102. The plurality of fan-shaped primary grooves 101 are located at the high-pressure side of the end surface of the sealing ring, and each fan-shaped primary groove 101 converges from the high-pressure side to the low-pressure side, i.e., a radial width of the fan-shaped primary groove 101 gradually decreases from the high-pressure side to the low-pressure side, which can allow the fan-shaped primary groove 101 to generate a hydrostatic effect and avoid friction and wear at the end surface of the sealing ring. Each fan-shaped primary groove 101 includes the plurality of stepped grooves 1011 that are distributed in the direction from the high-pressure side to the low-pressure side and adapted for laser processing. The number of stepped grooves 1011 in a single fan-shaped primary groove 101 ranges from 8 to 12. The greater the number of stepped grooves 1011, the better an effect of enhancing the hydrostatic effect, which can ensure stability of a fluid film. A depth of a single stepped groove 1011 (i.e., a step height of the single stepped groove 1011) may range from 2 μm to 5 μm. Stepped grooves 1011 within this depth range are adapted for laser processing and have excellent sealing performance. A radial groove wall line of the stepped groove 1011 may be a straight line, a circular arc line, or a spiral line. When the radial groove wall line of the stepped groove 1011 is the spiral line, the spiral line has a helix angle ranging from 80° to 90°, which can enhance a hydrodynamic effect of the stepped groove 1011 at the high-pressure side and further improve a bearing capacity of the sealing ring. Through the rational design, a leakage rate can be maintained within a relatively stable range under variable rotational speeds. The depth of each fan-shaped primary groove 101 increases equidistantly in the direction from the high-pressure side to the low-pressure side, which can obtain a fluid film with a relatively large thickness. The equidistant increase in the depth of the fan-shaped primary groove 101 is adapted for laser processing, featuring convenience and efficiency. The plurality of reverse grooves 102 are located at the low-pressure side of the end surface of the sealing ring, and are separated from the fan-shaped primary grooves 101 by the first dam region 103. When the rotating ring rotates, the reverse grooves 102 may pump a fluid radially and tangentially, which increases fluid pressure at the low-pressure side, and thus can effectively reduce sealing leakage. A radial groove wall line of each of the plurality of reverse grooves 102 is a logarithmic spiral line, an Archimedean spiral line, a straight line, or a circular arc line. The depth of the reverse groove 102 ranges from 15 μm to 25 μm. Each of the plurality of reverse grooves 102 has the same depth.

The working principle of the primary-secondary double-row shallow-groove mechanical seal end-surface structure 1000 adapted for laser processing according to the embodiments of the present disclosure is as follows. When the rotating ring is in a static state or normal operation state, since the plurality of fan-shaped primary grooves 101 are arranged at the high-pressure side of the end surface of the sealing ring, and each of the plurality of fan-shaped primary grooves 101 converges from the high-pressure side to the low-pressure side and includes the plurality of stepped grooves 1011 distributed in the direction from the high-pressure side to the low-pressure side, a high-pressure fluid may enter the end surface of the sealing ring through the stepped grooves 1011 of the sealing ring, which can effectively generate and enhance the hydrostatic effect, increase a thickness of a fluid film between the rotating ring and the stationary ring, and thus effectively avoid friction and wear at the end surfaces of the rotating ring and the stationary ring. The leaked fluid enters the end surface of the sealing ring through the stepped grooves 1011 and then flows into the reverse grooves 102 at the end surface of the sealing ring. When the rotating ring rotates, under a throttling effect of a second dam region 104 and a second weir region 106, the reverse grooves 102 pump the fluid radially and tangentially, which increases the fluid pressure at the low-pressure side, and thus can effectively reduce the sealing leakage. Meanwhile, a relatively large fluid film thickness is maintained to avoid collision and wear between sealing rings, and good rigidity is achieved. Moreover, as the rotational speed increases, a reverse pumping effect on the low-pressure side is enhanced, and the leakage rate is further reduced.

With the primary-secondary double-row shallow-groove mechanical seal end-surface structure 1000 adapted for laser processing according to the embodiments of the present disclosure, by combining the hydrodynamic effect and the hydrostatic effect of the fluid, on the one hand, when the rotating ring is in the static state or normal operation state, a fluid film with a relatively large thickness can be obtained, which can effectively avoid the friction and wear at the end surfaces of the rotating ring and the stationary ring, thus prolonging a service life of a sealing device. On the other hand, through the reverse pumping effect of the reverse grooves 102 at the low-pressure side, the leakage of the sealing device is inhibited, and a sealing leakage rate is effectively reduced, thus achieving a favorable sealing effect. Therefore, the primary-secondary double-row shallow-groove mechanical seal end-surface structure 1000 adapted for laser processing according to the embodiments of the present disclosure is applicable to low-rotational-speed operating conditions, which can realize the opening of the end surfaces at zero rotational speed, simultaneously achieve advantages of small wear and a low leakage rate at the end surface of the sealing ring, satisfy performance requirements of the sealing device for a long service life, high rigidity, and low leakage, and be adapted for laser processing with convenient manufacturing.

In some embodiments, a size of a single reverse groove 102 is smaller than a size of a single fan-shaped primary groove 101. This design can maintain the stability of the fluid film. Moreover, the reverse groove 102 has a relatively small size, which can save a space.

In some embodiments, a radial proportion of each of the plurality of reverse grooves 102 ranges from 0.1 to 0.15, and a radial proportion of each of the plurality of fan-shaped primary grooves 101 ranges from 0.6 to 0.8.

In some embodiments, the radial proportion of the reverse groove 102 ranges from 0.1 to 0.15, meaning that a ratio of a width of the reverse groove 102 in a radial direction to a width of the sealing ring surface in the radial direction ranges from 0.1 to 0.15, which can ensure a fluid pumping capacity at the low-pressure side. The radial proportion of the fan-shaped primary groove 101 ranges from 0.6 to 0.8, meaning that a ratio of a width of the fan-shaped primary groove 101 in the radial direction to the width of the sealing ring surface in the radial direction ranges from 0.6 to 0.8, which can ensure the stability of the fluid film and the sealing effect of the mechanical sealing device.

In some embodiments, a depth of a single stepped groove 1011 ranges from 2 μm to 5 μm. Stepped grooves 1011 within this depth range are adapted for laser processing and have excellent sealing performance. A depth of each of the plurality of reverse grooves 102 ranges from 15 μm to 25 μm, featuring a rational design.

In some embodiments, a radial groove wall line of each of the plurality of stepped grooves 1011 is a straight line, a circular arc line, or a spiral line.

In some embodiments, the primary-secondary double-row shallow-groove mechanical seal end-surface structure 1000 adapted for laser processing according to the embodiments of the present disclosure may be applied to shaft-end sealing of various rotating machinery, such as pumps, compressors, stirred tanks, and reactors. The radial groove wall line of the stepped groove 1011 may be selected as desired, resulting in wide applicability.

In some embodiments, as shown in FIG. 2, the spiral line has a helix angle ranging from 80° to 90°, which can enhance the hydrodynamic effect of the stepped groove 1011 at the high-pressure side and further improve the bearing capacity of the sealing ring. Through the rational design, the leakage rate can be maintained within a relatively stable range under variable rotational speeds.

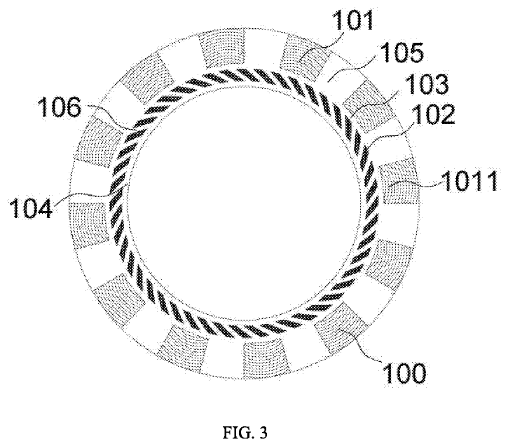

In some embodiments, as shown in FIG. 3, a curvature of a circumferential inner groove wall line of each of the plurality of stepped grooves 1011 is greater than or equal to a curvature of the sealing ring.

In some embodiments, the curvature of the circumferential inner groove wall line of the stepped groove 1011 is greater than or equal to the curvature of the sealing ring. When the curvature of the circumferential inner groove wall line of the stepped grooves 1011 is greater than the curvature of the sealing ring, a center of a circle of the circumferential inner groove wall line of the stepped groove 1011 is not coincident with a center of the sealing ring, but is offset by a predetermined distance in a radial direction of the sealing ring. Through the rational design, the hydrostatic effect of the stepped groove 1011 at the high-pressure side can be adjusted.

In some embodiments, a radial groove wall line of each of the plurality of reverse grooves 102 is a logarithmic spiral line, an Archimedean spiral line, a straight line, or a circular arc line.

In some embodiments, the primary-secondary double-row shallow-groove mechanical seal end-surface structure 1000 adapted for laser processing according to the embodiments of the present disclosure may be applied to the shaft-end sealing of various rotating machinery such as pumps, compressors, stirred tanks, and reactors. The radial groove wall line of the reverse groove 102 may be selected as desired, resulting in wide applicability.

In some embodiments, the number of fan-shaped primary grooves 101 ranges from 12 to 24, which can ensure the sealing effect of the mechanical sealing device. The number of stepped grooves 1011 in a single fan-shaped primary groove 101 ranges from 8 to 12. The greater the number of stepped grooves 1011, the better the effect of enhancing the hydrostatic effect, which can ensure the stability of the fluid film. The number of reverse grooves 102 ranges from 48 to 96, which can ensure the fluid pumping capacity of the reverse grooves 102.

In some embodiments, in a radial direction of the end surface of the sealing ring, a first dam region 103 is formed between a circular ring region where the plurality of fan-shaped primary grooves 101 are located and a circular ring region where the plurality of reverse grooves 102 are located, and a second dam region 104 is formed at an inner side of the circular ring region where the plurality of reverse grooves 102 are located. In a circumferential direction of the end surface of the sealing ring, a first weir region 105 is formed between every two adjacent fan-shaped primary grooves 101 in the plurality of fan-shaped primary grooves 101, and a second weir region 106 is formed between every two adjacent reverse grooves 102 in the plurality of reverse grooves 102.

In some embodiments, the fan-shaped primary grooves 101 may be separated from the reverse grooves 102 by the first dam region 103. When the reverse grooves 102 pump the fluid radially and tangentially, the second dam region 104 and the second weir region 106 may play a throttling role, increasing the fluid pressure at the low-pressure side and thus effectively reducing the sealing leakage.

Throughout this specification, description with reference to “an embodiment”, “some embodiments”, “an illustrative embodiment”, “an example”, “a specific example”, “some examples”, or the like means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Further, the particular features, structures, materials, or characteristics described here may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A primary-secondary double-row shallow-groove mechanical seal end-surface structure adapted for laser processing, comprises:
a double-row groove structure arranged in a centrosymmetric distribution at an end surface of a sealing ring,
wherein the double-row groove structure comprises:
a plurality of fan-shaped primary grooves located at a high-pressure side of the end surface of the sealing ring; and
a plurality of reverse grooves located at a low-pressure side of the end surface of the sealing ring,
wherein each of the plurality of fan-shaped primary grooves converges from the high-pressure side to the low-pressure side, each of the plurality of fan-shaped primary grooves comprises a plurality of stepped grooves distributed in a direction from the high-pressure side to the low-pressure side and adapted for laser processing, and a depth of each of the plurality of fan-shaped primary grooves increases equidistantly in the direction from the high-pressure side to the low-pressure side, and
wherein each of the plurality of reverse grooves has the same depth.

2. The primary-secondary double-row shallow-groove mechanical seal end-surface structure adapted for laser processing according to claim 1, wherein a size of a single reverse groove is smaller than a size of a single fan-shaped primary groove.

3. The primary-secondary double-row shallow-groove mechanical seal end-surface structure adapted for laser processing according to claim 2, wherein a radial proportion of each of the plurality of reverse grooves ranges from 0.1 to 0.15, and a radial proportion of each of the plurality of fan-shaped primary grooves ranges from 0.6 to 0.8.

4. The primary-secondary double-row shallow-groove mechanical seal end-surface structure adapted for laser processing according to claim 1, wherein a depth of a single stepped groove ranges from 2 μm to 5 μm, and a depth of each of the plurality of reverse grooves ranges from 15 μm to 25 μm.

5. The primary-secondary double-row shallow-groove mechanical seal end-surface structure adapted for laser processing according to claim 1, wherein a radial groove wall line of each of the plurality of stepped grooves is a straight line, a circular arc line, or a spiral line.

6. The primary-secondary double-row shallow-groove mechanical seal end-surface structure adapted for laser processing according to claim 5, wherein the spiral line has a helix angle ranging from 80° to 90°.

7. The primary-secondary double-row shallow-groove mechanical seal end-surface structure adapted for laser processing according to claim 1, wherein a curvature of a circumferential inner groove wall line of each of the plurality of stepped grooves is greater than or equal to a curvature of the sealing ring.

8. The primary-secondary double-row shallow-groove mechanical seal end-surface structure adapted for laser processing according to claim 1, wherein a radial groove wall line of each of the plurality of reverse grooves is a logarithmic spiral line, an Archimedean spiral line, a straight line, or a circular arc line.

9. The primary-secondary double-row shallow-groove mechanical seal end-surface structure adapted for laser processing according to claim 1, wherein the number of fan-shaped primary grooves ranges from 12 to 24, the number of stepped grooves in a single fan-shaped primary groove ranges from 8 to 12, and the number of reverse grooves ranges from 48 to 96.

10. The primary-secondary double-row shallow-groove mechanical seal end-surface structure adapted for laser processing according to claim 1, wherein:
in a radial direction of the end surface of the sealing ring, a first dam region is formed between a circular ring region where the plurality of fan-shaped primary grooves are located and a circular ring region where the plurality of reverse grooves are located, and a second dam region is formed at an inner side of the circular ring region where the plurality of reverse grooves are located; and
in a circumferential direction of the end surface of the sealing ring, a first weir region is formed between every two adjacent fan-shaped primary grooves in the plurality of fan-shaped primary grooves, and a second weir region is formed between every two adjacent reverse grooves in the plurality of reverse grooves.
